(19) United States
(12) Patent Application Publication
(10) Pub. No.: US 2012/0044358 A1
(43) Pub. Date: Feb. 23, 2012

(54) AUTOMATIC CONFIGURATION

(75) Inventors: Graham Thomason, Surrey (GB); Andrew Thomas Yule, East Grinstead (GB)

(73) Assignee: U-Blox AG, Thalwil (CH)

(21) Appl. No.: 13/202,973

(22) PCT Filed: Feb. 23, 2010
(86) PCT No.: PCT/GB10/50309

§ 371 Date: Nov. 4, 2011

(30) Foreign Application Priority Data
Feb. 24, 2009 (GB) 0903063.6

(51) Int. Cl. H04N 17/00

(52) U.S. Cl. 348/175; 348/E17.002

(57) ABSTRACT

A method of automatically configuring a device. The method comprises: obtaining an image of a scene comprising a machine-readable code containing configuration information for the device; processing the image to extract the configuration information; and using the configuration information to configure the device. The step of obtaining the image comprises at least one of: capturing the image using a camera; or receiving the image captured by a camera. The configuration information comprises date or time information.

This invention relates to the configuration or programming of an electronic device by means of an image. In particular, it relates to programming a camera or programming a computer adapted to receive images from a camera.

With advances in technology and reductions in the cost of high-quality image sensors, digital photography has become increasingly popular. The range of cameras available to the consumer includes camera-phones, as well as digital still cameras and video cameras. The widespread availability of diverse camera technology leads to two problems: firstly, how to make it easier for users to capture images (or videos) with multiple different types of camera, preferably without having to spend large amounts of time studying how to operate each one individually and configuring settings; and secondly, how to manage the large collections of images that are so easily and rapidly generated.

Regarding the first problem, it can often be tedious to configure a complex camera properly. This problem is exacerbated if a single user regularly uses different camera equipment (for example, a camera-phone and a separate digital still camera). The need to configure diverse cameras may cause user confusion and frustration, as a result of wasted time. Regarding the second problem, it is known to be advantageous to provide images (or videos) with position metadata, indicating their location of capture. Location information is a useful key for subsequent browsing and searching of a collection of images. These advantages can be provided by associating a satellite positioning receiver with the camera. An example is a receiver for the Global Positioning System (GPS). Such a receiver may be integrated in the camera or connected to it. Alternatively, it may be independent of the camera, such that the position data generated by the GPS receiver is only associated with the images at some later time (for example, when the camera and the GPS receiver are connected to a computer).

GPS receivers can be categorised into two broad classes: real-time receivers, which process satellite signals to compute position information at the time the signals are being received from the satellites; and “capture and process later” (hereinafter “capture-and-process”) receivers, which sample and store the satellite broadcasts for later processing.

The GPS signals transmitted by the satellites are of a form commonly known as Direct Sequence Spread Spectrum employing a pseudo-random code which is repeated continuously in a regular manner. The satellites broadcast several signals with different spreading codes including the Coarse/Acquisition or C/A code, which is freely available to the public.

A data message is modulated on top of the C/A code by each satellite and contains important information such as detailed orbital parameters of the transmitting satellite (called ephemeris), information on errors in the satellite's clock, status of the satellite (healthy or unhealthy), current date, and time. This part of the signal is essential to a GPS receiver determining an accurate position. Each satellite only transmits ephemeris and detailed clock correction parameters for itself and therefore an unaided GPS receiver must process the appropriate parts of the data message of each satellite it wants to use in a position calculation. A conventional GPS receiver reads (that is, decodes) the transmitted data message and saves the ephemeris and other data for continual use. This information can also be used to set (or correct) the clock within the GPS receiver.

A complete data signal from the satellites consists of a 37,500 bit Navigation Message, which takes 12.5 minutes to send at 50 bps. The data signal is divided into 25 30 s frames, each having 1500 bits, and these are divided into five 6 s sub-frames. Each 6 s sub-frame is divided into ten 30 bit words. All the information necessary for a position fix (ephemeris, and other information) is contained within each frame and so a conventional GPS receiver will typically take around 30 s to produce a position fix from a so-called cold start.

Such conventional, real-time GPS receivers invariably comprise:
an antenna suitable for receiving the GPS signals,
analogue RF circuitry (often called a GPS front end) designed to amplify, filter, and mix down to an intermediate frequency (IF) the desired signals so they can be passed through an appropriate analogue-to-digital (ND) convertor at a sample rate normally of the order of a few MHz,
digital signal processing hardware that carries out the correlation process on the IF data samples generated by the A/D converter, normally combined with some form of micro controller that carries out the “higher level” processing necessary to control the signal processing hardware and calculate the desired position fixes.

The less well known concept of “Capture-and-Process” has also been investigated. This involves storing the IF data samples collected by a conventional antenna and analogue RF circuitry in some form of memory before processing them at some later time (seconds, minutes, hours or even days) and often at some other location, where processing resources are greater.

The key advantages of the Capture and Process Later approach over conventional GPS receivers are that the cost and power consumption of the capturing device are kept to a minimum as no digital signal processing needs be done at the time of capture, and the grabs can be very short (for example, of the order of 200 ms). If the subsequent signal processing is done when the relevant satellite data (including ephemeris) can be obtained via some other method, this approach also removes the need to decode the data message from the satellites (or “Space Vehicles”—SVs) in the capturing device. In many cases, this decoding step leads to unacceptably long times to start up conventional, real-time devices.

A simple capture device which stores short “grabs” of IF data samples into memory can subsequently upload these IF data grabs to a computer. The computer not only carries out the necessary signal processing (correlation etc), but would also have access to a database of recent satellite information (including ephemeris) by being connected to one or more conventional GPS receivers which relayed key parts of the GPS data message they received to the central computer. The use of ephemeris data from a separate source is often referred to in the literature as “assisted GPS” (A-GPS) and appropriate methods for this kind of processing will be well known to those skilled in the art.

In capture-and-process GPS, it is desirable to store as little data as possible to reduce memory and processing requirements, but this makes obtaining a position fix more difficult. In order to use a short capture (for example, 200 ms) to obtain a fix, it is beneficial to establish the Coordinated Universal Time (UTC) of the capture to an accuracy of within a few minutes. When the GPS signal samples are processed (for example, at the computer) this UTC time can be used to obtain the ephemeris and other satellite data corresponding to the time of capture. An accurate initial estimate of UTC time can significantly reduce the search space for the correlation task and thus make the process of calculating a position fix faster, more efficient, or both.

Note that a capture of approximately 6 seconds would ordinarily be necessary to compute UTC from received GPS signals; however, this is much longer than the desired capture length of hundreds of milliseconds, in the capture-and-process scenario. Therefore, for capture-and-process GPS receivers, there is a need to determine UTC time to a reasonable degree of accuracy, by some other means.

According to an aspect of the present invention, there is provided a method of automatically configuring a device, the method comprising: obtaining an image of a scene comprising a machine-readable code containing configuration information for the device; processing the image to extract the configuration information; and using the configuration information to configure the device, wherein the step of obtaining the image comprises at least one of: capturing the image using a camera; or receiving the image captured by a camera, and wherein the configuration information comprises date or time information.

The method provides for automatic configuration of a device using visual input. A photograph of a machine-readable code is analysed to extract the embedded configuration information of the code and the decoded information is used to configure a device. In general, the machine-readable code may be presented in a wide variety of suitable forms. For example, traditional machine-readable symbols, such as one- or two-dimensional barcodes can be used. Equally, the code might comprise human-readable text suitable for optical character recognition. The only requirement is that the image of the code can be analysed automatically to decode the embedded configuration information. The appearance of the code will vary according to the configuration information that it embodies. In this context, configuration information means any kind of information which could be used to modify the operation of the intended device. This can include, for example, parameters for a method carried out by the device or other settings of the device. More generally, it may even include instructions for a method (for example, in the form of a software or firmware program). The method can provide an advantageous way to input configuration information, particularly for cameras or other devices commonly connected to a camera or receiving images from a camera by any means. In these cases, the use of visual input may eliminate the need to provide additional interfaces for inputting configuration information.

Preferably, the configuration information includes date and time information—for example, a UTC time.

The device to be configured may process the image to extract the configuration information.

This means that the device which it is desired to configure performs the necessary image processing itself. The image of the machine-readable code can thus be processed as late as possible—that is, at the time that it is desired to use the configuration information. In this way, the visual content of the image represents a portable, latent instruction to configure a given device in a given way. This may be particularly beneficial when the device to be configured is not the camera which captured the image (that is, which took the photograph).

The device to be configured may be the camera which captured the image.

Visual input of configuration information to a camera can be particularly effective, since the camera can be configured automatically simply by taking a photo of the relevant machine-readable code. This can eliminate the need to provide a separate or additional interface for the input of configuration information. For example, the user interface and controls of the camera may be made much simpler and easier to use, as a result.

The step of using the configuration information may comprise setting an internal clock of the camera.

Configuring the camera clock is one advantageous application of the invention. Date and/or time information can easily be provided in machine-readable form. The data payload of the machine-readable code is small, but the user of the camera may be saved a great deal of inconvenience. Furthermore, taking a picture which contains an embedded accurate time is a very accurate way of setting the clock, since it is instantaneous. This contrasts with manual setting of a camera clock (for example by pressing control buttons on the camera), since it is difficult for the user to accurately synchronise the clock, even if an accurate reference is available. As described earlier above, accurate time information may be beneficial in the context of GPS positioning, using capture-and-process methods.

The configuration information may further comprise photographic parameters for the camera.

Photographic settings are a particularly suitable use of the invention, since they can be tedious to set manually and are also subject to frequent change. For example, a set of machine-readable codes (in a camera manual) could be used to quickly switch between different photography modes, such as a continuous-shooting mode and a macro-mode. Note that input photographic settings are to be distinguished from the mere measurement or correction of distortions. For example, calibration patterns for correcting lens distortion do not constitute a machine-readable code comprising configuration information, since the information needed to make the adjustment is not inherent or intrinsic in the pattern. The same is true of colour calibration cards for correcting white balance. In both these examples, the calibration pattern itself does not encode any configuration information—rather, the pattern allows environmental conditions or distortions to be measured.

The device to be configured may be a computer adapted to receive images from the camera which captured the image.

This can be particularly beneficial in circumstances where the configuration information is available at the time the photograph is taken and it is desired to configure a computer—for, example a personal computer with which the user maintains a digital image collection. It may be particularly advantageous to defer the processing of the image until it has been transferred to the computer. This implements the variation of the method discussed above, in which the device to be configured (that is, the computer) extracts the configuration information from the image. A computer will typically have greater computational resources for processing the image, compared with a camera. If there is no need for the camera to extract the configuration information, then there may be no need for the camera to be modified to enable it to be used in a method according to the invention. In this way, existing cameras could be used, without adaptation, to implement the method.

Preferably, the image is associated with time-of-capture metadata generated by an internal clock of the camera; and the step of using the configuration information comprises comparing the date or time information with the metadata to calculate a relative error of the internal clock of the camera.

Using this method, it is possible to later determine the error or offset of the camera's internal clock, without the need for the camera to decode the latent configuration information (that is, the time information) immediately upon capture of the image. Similarly, there is no need to actually correct the internal clock itself. As described earlier above, accurate time information may be beneficial in the context of GPS positioning, using capture-and-process methods. Preferably, the time information comprises an indication of UTC time.

Preferably, the decoding of the time information and its comparison with the time-of-capture metadata can take place at the time that the position fix is being calculated, and/or in the same apparatus. This matches the overall approach of capture and process later, by deferring as much processing as possible to a later time. As mentioned above, this may also allow the invention to be implemented with a conventional camera. That is, the user may take advantage of the invention without the need to buy a new, specially-designed or adapted camera. This advantage is particularly relevant in the case that a capture-and-process GPS receiver is provided as an external accessory.

The method may further comprise extrapolating the calculated relative error, so as to calculate the time of capture of other images captured by the same camera.

The time information provided in the machine-readable code preferably represents an accurate reference time, for example, UTC time. Assuming the behaviour of the camera's internal clock is known and relatively stable over a reasonable period, the relative error with respect to the reference can be extrapolated to other images captured by the camera in the period. For example, if a constant error is assumed, the UTC time of capture of any image can be deduced by adding or subtracting the appropriate offset to the time-of-capture metadata recorded by the camera's internal clock for that image. This can enable the time of capture of the image to be calculated more accurately—for example, if the internal clock of the camera is set inaccurately, or to a time-zone other than UTC.

The method may also comprise using the calculated time of capture of at least one of the images in a method of processing satellite positioning signals, so as to compute a location of capture.

This represents a particularly advantageous use of the machine-readable configuration information contained in the image content. By conveniently enabling a UTC estimate to be associated with each photograph, the method can allow GPS (for example) signal samples associated with the place of capture of the photograph to be efficiently processed. That is, a set of GPS signal samples associated with the image can be processed to deduce the location where the image was taken. As already outlined above, an accurate estimate of UTC time is very beneficial in this process, since it allows a reduction and focusing of the computational effort to derive the position fix from a short sequence of GPS samples.

The scene comprising the machine-readable code may comprise a display apparatus showing the machine-readable code, wherein the display is at least one of: a display of a device connected to a communications network for retrieving the configuration information; a display of a satellite positioning receiver; and a display of a clock.

The machine readable code may advantageously be provided from a remote source via a network (for example, the internet, or a mobile communications network). One example where this is of special benefit is when the configuration information comprises time information. In this case, an accurate reference clock can be provided centrally, for example in an automatically updating web-page. The code can then be displayed on a display screen of a device which accesses this central provider—for example, a web-browser of a mobile phone or computer. Of course, central updating of the machine readable code will be advantageous in many other circumstances—for example, where it is desired to update device settings or firmware to fix a bug. A satellite positioning (for example, GPS) receiver is another potentially useful source of configuration information, especially time information. For example, a clock on a display of a GPS receiver could be photographed. This can subsequently allow the timing of photographs taken by the camera to be accurately aligned with the timing of captures of satellite signals by the receiver, even if the camera is not connected to the receiver when taking the photos. Note that, in every case, the display may be human- and machine-readable or only machine-readable.

According to a further aspect of the invention, there is provided a computer program comprising computer program code means adapted to perform all the steps of a method of the invention when said program is run on a computer.

The computer program may be embodied on a computer-readable medium.

According to another aspect of the invention, there is provided apparatus for automatic configuration of a device, the apparatus comprising: input means, for receiving an image of a scene comprising a machine-readable code containing configuration information for the device; and a processor adapted to process the image to extract the configuration information; and adapted to use the configuration information to configure the device, wherein the configuration information comprises date or time information.

The invention will now be described by way of example with reference to the accompanying drawings, in which:

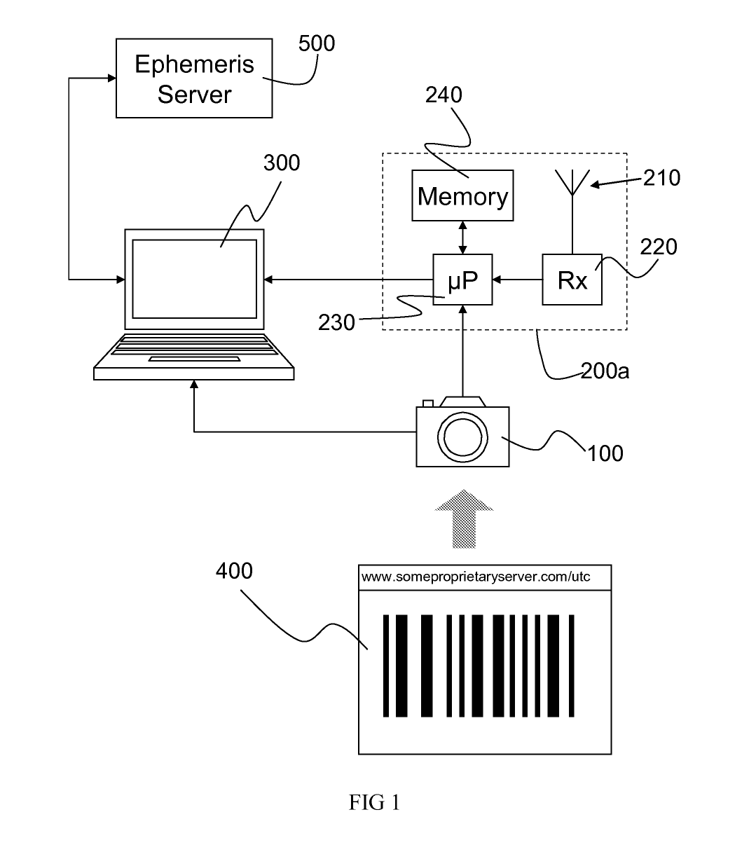

FIG. 1 shows a block diagram of apparatus operating in accordance with an embodiment of the invention;

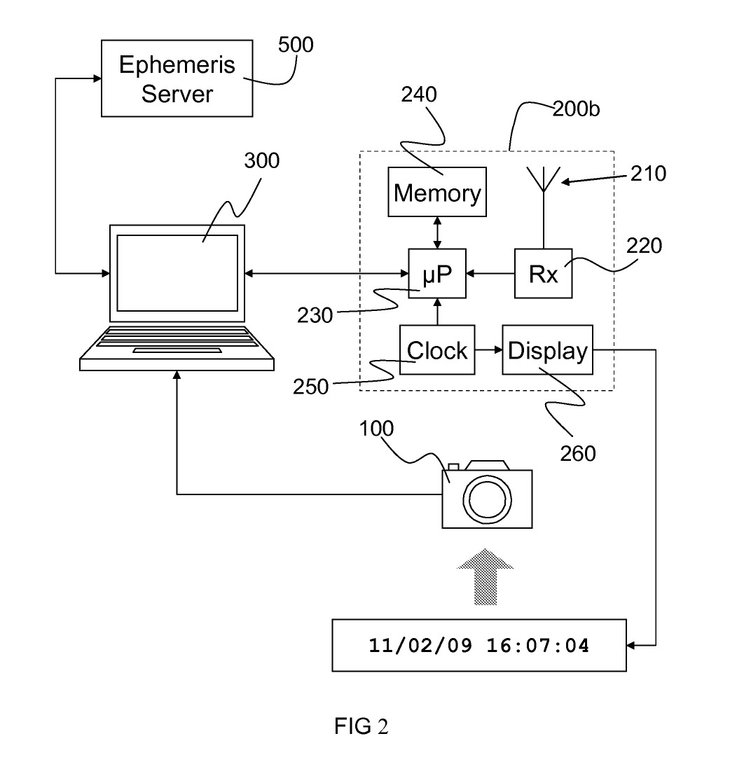

FIG. 2 shows a block diagram of apparatus operating in accordance with another embodiment;

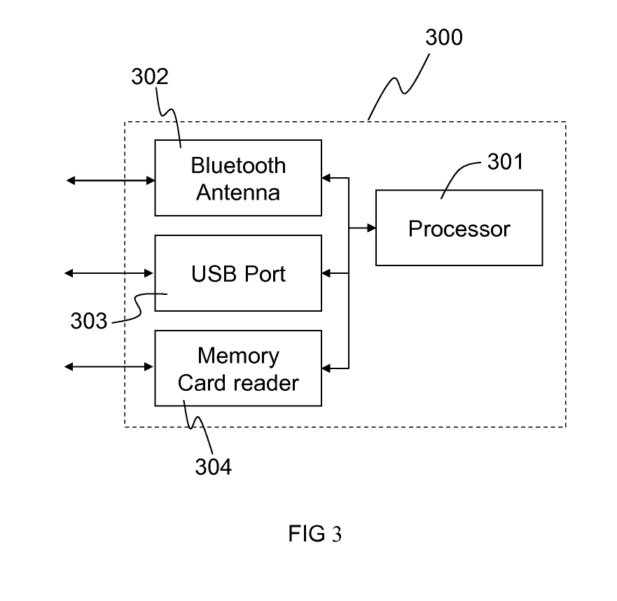

FIG. 3 is a simple block diagram of a computer adapted to implement an embodiment;

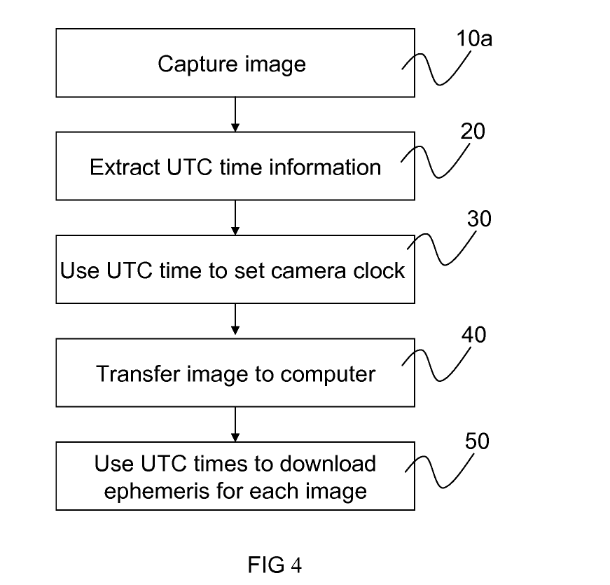

FIG. 4 is a flow chart illustrating a method according to an embodiment; and

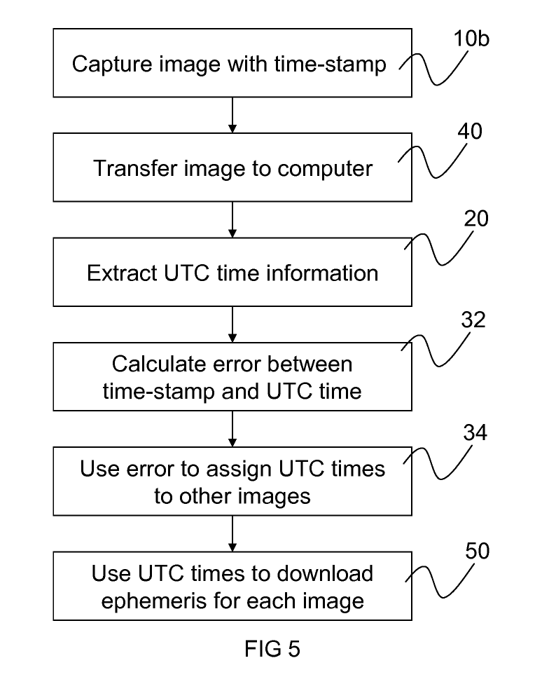

FIG. 5 is a flow chart illustrating a method according to another embodiment.

The inventors have recognised that it will be beneficial to provide a quick and convenient way for a user to associate an accurate UTC time with photographs and/or associated GPS captures. As discussed above, an accurate UTC time enables efficient calculation of position from a short GPS grab, in the capture-and-process scenario. This scenario is particularly appropriate for photography applications, because a capture-and-process receiver is a much simpler and cheaper technology than a full, real-time GPS receiver.

However, the inventors have also recognised a more general need to configure other properties of a camera. A particularly elegant solution to this problem is to use a picture taken by the camera to configure the camera. In devising this solution, the inventors have realised that the lens and sensors of the camera represent a useful input channel—not just for images themselves but also for configuration data, which can be embedded in those images by placing it in the field of view of the lens in a machine-readable form. The processing power already commonly provided in a digital camera or camera-phone can then be used to decode the input configuration data.

This method of programming by visual input is not limited to the programming of the camera itself. The camera can take a picture containing embedded configuration information and store it, for later use by any other device. So, for example the image recorded by the camera can be used to configure a computer to which the camera uploads its images. By extension, the computer may use the configuration information to configure another attached peripheral. Indeed, the computer may decode the configuration information and use it to configure the same camera which was used to take the picture. In this case, the camera does not need to be aware of the significance of the image—it merely takes a picture as normal, uploads it to a computer, and receives configuration information. It is possible to imagine an extreme case in which all the image processing settings of the camera could be held only as images. These images would be interpreted and used to configure the camera only during later processing (for example, at the computer).

This powerful and general method of configuration is particularly useful in the context of geo-tagging. Geo-tagging refers to the association of location metadata with media, especially images. The invention will now be described in detail in the context of this application, by way of example. Of course, as the skilled person will understand, the benefits of the invention are not limited to this application.

In a first exemplary embodiment of the invention, a configuration method is used to provide an accurate time reference for images captured by a camera, relative to UTC. As explained earlier above, knowledge of the UTC time of capture is very helpful when processing a short sequence of captured GPS signal samples, in order to compute a position fix. As also explained above, associating position information with an image is desirable. In this embodiment, configuration information input visually to the camera is used to enhance the calculation of the position fix, by including UTC time information in the configuration information. Such a position fix can then be associated with its corresponding image.

The first embodiment will now be described with reference to FIGS. 1 and 4. FIG. 1 shows a system operating in accordance with the embodiment. This system comprises a camera 100; a capture-and-process later GPS receiver 200a; and a personal computer (PC) 300. The PC is connected, for example, via the internet, to an ephemeris server 500, which contains a historical database of ephemeris and other satellite information for all the GPS satellites.

In this example embodiment, the camera 100 is connected to the GPS receiver 200a such that the receiver captures a snapshot of GPS signal samples each time the camera takes a picture. This can be achieved by equipping the camera 100 with an external GPS receiver 200a, or by integrating the receiver 200a in the camera itself.

The receiver 200a comprises an antenna 210 and GPS front-end 220, connected to a micro-processor 230 and memory 240. The front-end 220 performs the functions of down-conversion of the satellite signals to IF followed by analogue to digital conversion. Each time the camera 100 captures an image, a snapshot comprising a short sequence of digitised IF signal samples is stored in the memory 240.

If the GPS receiver 200a is embedded in the camera 100, then the captured satellite-signal samples can be stored together with, or even in, the image-file. If the GPS receiver 200a is external to the camera, the trigger-signal (shutter-release) can be delivered via the camera hot-shoe. The hot-shoe connection is commonly used for connection of an external flash to a camera.

When the receiver 200a is connected to a PC 300, the stored data samples are uploaded. The PC processes the IF data samples to calculate a position fix, using appropriate, well-known position estimation techniques. In the process of this calculation, as discussed earlier above, it is beneficial to have an estimate of the UTC time of capture of each snapshot. For example, this can enable the PC to retrieve the correct corresponding ephemeris and other satellite data from the ephemeris server 500. A method according to the first embodiment of the invention can provide this UTC time estimate as follows.

To obtain UTC time information, the camera takes a picture of a scene including a machine readable code. This is illustrated in step 10a of FIG. 4. For example, the user of the camera can point the camera 100 at a web-page 400 and capture an image of it. This web-page 400 displays a continuously updating bar-code, which encodes the current UTC time.

The camera then processes the captured image (step 20) to extract the UTC time information. Image-processing or machine-vision methods for detecting and recognising bar-codes in images are well known in the art. Once recognised, the bar-code is decoded to reveal the UTC time information. At step 30, the extracted UTC time is used to set an internal clock in the camera correctly to UTC.

It is common practice to embed time-of-capture metadata in image files created by a digital camera. For example, this metadata can be provided in a relevant field of the Exchangeable Image File Format (Exif), for JPEG images. Since the internal clock of the camera 100 has now been set accurately to UTC time, all subsequent images captured by the camera will contain an accurate UTC time-stamp. Optionally, it would also be possible to correct the time stamps of previously captured images, using a measured offset (error) between the UTC time information provided by the bar code and the time-of-capture metadata assigned to the bar-code image by the camera's internal clock. In other words, it is possible to calculate the relative error of the camera's internal clock (before correction) and extrapolate this to retrospectively correct the time-of-capture metadata for all images.

As noted above, in this embodiment, the GPS receiver captures a snapshot each time a photo is taken. Therefore, the accurate UTC time stamp for each image is the same as the UTC time of capture of the GPS snapshot.

In step 40 the camera transfers its images (and their embedded UTC time metadata) to the PC. If the receiver 200a is integrated in the camera, then the snapshots may be transferred to the PC in the same step, and using the same communications interface. If the receiver 200a is external to the camera, the snapshots are transferred independently.

In step 50, the UTC time metadata in each image is used by the PC to retrieve the corresponding ephemeris and other satellite information for the satellites at the time the image was captured. This information can then be used, together with the respective snapshots, to derive a position fix for each image. An accurate (UTC) time estimate means that the positions and velocities of the visible satellites at that time can be predicted accurately. The better the estimates of satellite position and velocity the easier the position calculation becomes, since the number of correlation operations can be reduced. In this way, accurate prediction can remove the burden of exhaustive (brute-force) search.

A second embodiment of the invention is similar to the first, except that the PC 300 decodes and uses the configuration information. This second embodiment will now be described with reference to FIGS. 1 and 5.

In step 10b, the camera captures the image of the bar-code. In this embodiment it is a requirement that the camera 100 records time-of-capture metadata associated with the image. The image is transferred to the PC 300 in step 40 (potentially together with other images captured by the camera 100). Note that, unlike the first embodiment, the camera has not processed the image to extract the configuration information before transferring it. Instead the PC 300 performs this step 20. The processing can be identical to the first embodiment: image processing techniques are used to identify and decode the bar-code present in the image.

In step 32, the PC 300 then compares the extracted UTC time information with the time-of-capture metadata (for example, Exif tags) associated with the image. This comparison reveals the relative error between the internal clock of the camera, which produced the time-of-capture metadata, and UTC time. In step 34, the relative error is used to extrapolate the times of capture of the other images captured by the camera. This can be done, for example, by adding/subtracting the error to/from the time-of-capture metadata, as appropriate.

The assumption is that the offset between the camera's internal clock and UTC time is approximately constant and stable over time. In practice, the camera's clock will not keep perfect time and so the error is likely to change over time. This means that it will be necessary to re-synchronise periodically, using a method of the present invention, to ensure that excess error does not accumulate. Of course, if the characteristics of the camera's clock can be modelled more accurately, it may be possible to compensate more accurately for the relative error. For example, if it is known that the camera clock has a linear error function (accumulating a constant time error each hour or each day) then a linear correction can be applied.

In step 50, the extrapolated UTC times for each image are used by the PC to access the relevant ephemeris data for each time of capture. This step is identical to the first embodiment; and the ephemeris and other relevant satellite data can be used in the same way in a method of processing the GPS signals to compute the location of capture of each image.

Note that the second embodiment achieves many of the same advantages as the first embodiment; however, according to the second embodiment, instead of actively correcting the internal clock in the camera, a post-processing method is used to retrospectively compensate for an error in the clock.

In a third embodiment, a configuration method of the invention is used to link images captured by the camera with periodic GPS snapshots captured by an independent capture-and-process GPS receiver. This embodiment will now be explained with reference to FIGS. 2 and 5.

FIG. 2 shows an alternative implementation of the apparatus of FIG. 1, functioning according to the third embodiment the invention. Compared with the first and second embodiments, in the third embodiment the camera 100 and GPS receiver 200b are not connected, and so they do not communicate when the camera is taking photographs. Instead of capturing a GPS IF data snapshot each time the camera captures an image, the receiver 200b captures snapshots periodically.

The interval between captures is chosen so that a reasonably accurate track of the trajectory of the receiver can be generated from the snapshots. In practice, the actual interval used should preferably depend on how fast the user is expected to be travelling. In this embodiment, images captured by the camera 100 will later be associated with GPS snapshots independently captured by the receiver 200b. This will allow a position fix to be established for each image. Clearly, although receiver 200b and camera 100 are not connected, they should be kept together, to maximise the accuracy of the resulting location data. The position fix assigned to each image will actually be the position of the receiver at approximately the same time that the image was captured. For this approach to work accurately, it is necessary to align the time-of-capture metadata stored by the camera with the time of each GPS snapshot, in order that an accurate correspondence can be established.

For this purpose, the receiver 200b is provided with its own internal clock 250. It also has a display 260 which displays the current time, as determined by the clock. The clock 250 also generates a time-stamp for each of the GPS snapshots. These time-stamps are stored with the snapshots in the memory.

The camera 100 and PC 300 can operate according to either of the methods described above for the first and second embodiments. The only difference is that, in this third embodiment, the user uses the camera to capture an image of the display 260 on the GPS receiver 200b (instead of taking a photograph of the webpage 400). This will enable the time-of-capture metadata of the images capture by the camera to be aligned with the clock 250 of the GPS receiver 200b (instead of aligning with UTC time, provided by the webpage 400).

Taking the example of the method of the second embodiment, the image of the GPS display 260 is uploaded to the PC 300. The PC also receives the time-stamped GPS snapshots from the GPS receiver 200b. As before, the PC processes the image to extract the embedded time information. In the example of FIG. 2, the display 260 of the GPS receiver displays ordinary text (instead of a bar-code). The processing to extract the time information will therefore comprise Optical Character Recognition (OCR), to extract the time-configuration information from this human-readable time display. Of course, it is also possible that the display 260 shows a bar-code encoded time, like that of the website 400 described above.

The extracted time information is then compared with the time-of-capture metadata embedded in the image file by the camera. This results in a relative error between the extracted time (determined by the GPS receiver clock 250) and the embedded metadata (determined by the camera's internal clock). By compensating for this relative error, all the images uploaded from the camera can be aligned correctly with their nearest GPS snapshots, from the receiver 200b.

Of course, in order to calculate a position fix from each of the aligned GPS snapshots, an estimate of UTC time is still beneficial. This can be provided by a variety of means. One option is to provide the GPS receiver with an accurate clock 250 which is set to UTC time. The accuracy could be checked and the time corrected upon connection of the receiver 200b to the PC 300.

Another possibility is to combine the second and third embodiments of the invention, so that the user takes one picture of a web-page, providing a UTC time reference, and another picture of the GPS receiver display, providing a reference to the GPS receiver clock 250.

For completeness the internal structure of the PC 300 is shown in greater detail in FIG. 3. This shows that the PC comprises a processor 301; Bluetooth antenna 302; Universal Serial Bus (USB) port 303; and memory card reader 304. These components are all completely standard and will be familiar to those skilled in the art.

The processor can be adapted to perform processing methods according to embodiments of the invention. For example, according to the second embodiment, it is the processor which performs the step 20 of extracting the configuration information (UTC time information) from the image. In the same embodiment, the processor 301 may also use the extracted configuration information to configure the PC 300—in particular: by calculating the relative error, in step 32; extrapolating from this error to calculate the UTC time of capture of the other images, in step 34; and using the calculated times of capture in a method of processing satellite signals, by downloading ephemeris and other satellite data corresponding to those times, in step 50.

The Bluetooth antenna 302; Universal Serial Bus (USB) port 303; and memory card reader 304 are merely examples of suitable input means, which can be used to receive the image comprising the machine-readable code from the camera. The same or different input means can be used to receive the GPS signal captures from the GPS receiver 200.

As will already be apparent to the skilled person, different embodiments of the invention allow different devices to be configured using configuration data input to a camera 100 in the form of an image. In the first embodiment above, the camera itself was the device configured, since the configuration information (UTC time information, in the example) was used to set an internal clock of the camera.

In the second embodiment, the PC 300 was configured, since the configuration information (again, UTC time information) was used as a parameter in a method performed by the PC. Specifically, the time information was used by the computer in a method of processing satellite signals—by downloading ephemeris and other satellite data in dependence on times derived from the UTC time information.

In the third embodiment, the PC 300 was once again the device configured. Again, the latent configuration information embodied in the image was used to configure and control a method executed by the PC.

Of course, as will be readily apparent to the skilled person, devices other than cameras and PCs can be configured by configuration information provided in accordance with the invention. There are few limitations on the way the invention is applied. All that is required is a camera to capture the image comprising the configuration information, and a chain of communication to the device that is to be configured.

For example, a camera could be used to configure a printer: the camera captures an image of a bar-code representing printer settings; the printer then uses these settings when printing photographs transferred from the camera. In this example scenario, the camera may decode the configuration information and communicate it to the printer in the form of instructions. Equally, the camera may simply transfer the unprocessed image of the bar-code to the printer, which then extracts the configuration information itself. As a further alternative, a computer could be used as an intermediary: the camera transfers the raw image to the computer; the computer decodes the bar-code; and the computer configures the printer.

Another embodiment of the invention could be completely implemented in the camera. That is, the camera captures the configuration-image, decodes the embedded information and uses it, without reference to other devices. This may be useful—for example—for providing the camera with a set of photographic parameters.

It may be easier for a user to configure camera settings using the Graphical User Interface (GUI) of a computer than to use button and other controls on the camera itself. In one such example, the user could navigate to a web-page, which provides a complete interface for configuring the camera. Each setting can be presented and adjusted by the user in the manner most convenient—including using editable text-boxes, scroll wheels in conjunction with lists of parameters, radio buttons, and so forth. When the user is satisfied with the selection of all the settings, the web-interface converts the configuration data into a machine-readable code. The user can input all the settings into the camera by capturing a single image of this code.

Rather than provide an alternative user interface, to dynamically generate the configuration bar-code, a selection of fixed bar-codes could be provided to the user, corresponding to different modes of operation for the camera. These could be provided in a printed manual, for example. Bar-codes could equally well be attached to accessories with which the camera can be used. Before using the camera with the accessory, the user simply takes a photo of the bar-code, which automatically configures the camera appropriately for that accessory. This might be used, for example, to configure the camera for use with a particular flash-unit, or for use with a tripod. In each case, settings such as shutter speed, aperture or sensitivity might be adapted for the appropriate conditions.

It may be advantageous to provide the camera with a special mode for visually inputting configuration data. This would adapt the camera settings such that they are optimal for capturing a clear image of the machine-readable code, which would facilitate successful image processing to decode the configuration information. For example, if taking a photograph of a web-page, the flash might be disabled, to avoid glare or loss of contrast. The special mode could also alert the camera to apply the necessary processing and extraction methods, to decode the information (in the event that the camera is responsible for this part of the process). If the image is to be processed later, the image could be given a metadata item identifying it as a configuration image.

The foregoing description has used just two examples of the many kinds of machine readable code which could be applied in embodiments of the invention. The first example was a bar-code; and the second was a textual display showing the time. As will be readily apparent to those of ordinary skill in the art, the configuration information could be presented in a very wide variety of forms, far beyond the limits of these two examples. Other trivial variations related to bar-codes include two-dimensional codes such as Quick Response (QR) codes, and other similar matrix codes. These encode information in a dot matrix and are designed to have greater data densities than one-dimensional bar-codes. It is also known to provide machine readable codes based on colour matrices. Of course, the invention is not limited either to static codes—a greater volume of configuration information could be embedded in a code which comprises temporal variation. In this case, the camera would need to capture a video of the machine-readable time-varying code, instead of an image.

To the extent that OCR is feasible, printed or displayed text may also comprise a suitable machine-readable form. Other human-readable forms of information include examples like an (analogue) clock-face. Image-processing techniques could be used to extract time information from an image of such a clock-face, in a manner similar to OCR, or the detection of the bar elements of a bar code. Nonetheless, in general, it will be easier to process those forms of presentation—such as bar-codes and matrix codes—which have been designed specifically for machine reading.

It may also be possible to design codes specially adapted for use with cameras. For example, most existing digital still cameras use the JPEG image compression standard. This specifies methods for lossy Discrete Cosine Transform (DCT) encoding. It may therefore be advantageous to provide the machine-readable code in a form suitable to this type of image compression. For example, a code-image could be designed in the DCT transform domain, with information encoded by the coefficients of the transform. This could allow the information content to be concentrated on those frequency components which are less aggressively quantised by the JPEG encoding process. This would minimise the loss of configuration data through noise or distortion introduced by the camera when compressing the image of the code. It may also have the advantage of reducing complexity: since the image is stored in JPEG encoded form, it may not even be necessary to fully decode the image in order to access the configuration information, because the configuration can (potentially) be read directly from the transform coefficients.

When a bar-code is used to encode a time, the allocation of the digits of the time to the payload of the bar-code can be adapted according to the requirements of the application. For example, if accuracy of the time is required to within an interval of 10 seconds, and the time range before rollover (that is, the time between successive repetitions of the same code) is 3 years, then 7 decimal digits (or 24 binary digits, bits) are required. Standard barcodes support 10 decimal digits. Rollover is not a problem, provided it is not too frequent. If necessary, the processing software can try times corresponding to various rollovers. Often, only one instance will stand out as being consistent or valid. For example, if different times are used to download ephemeris and other satellite information when processing GPS signal samples, only one should give rise to a valid position fix.

If the machine-readable code has sufficient capacity, it may be used to carry larger amounts of configuration data. For example, the methods of the invention could be used to deliver software or firmware updates to the device to be configured.

Various other modifications will be apparent to those skilled in the art.

1. A method of automatically configuring a device, the method comprising:
obtaining an image of a scene comprising a machine-readable code containing configuration information for the device;
processing the image to extract the configuration information; and
using the configuration information to configure the device,
wherein the step of obtaining the image comprises at least one of:
capturing the image using a camera; or
receiving the image captured by a camera, and
wherein the configuration information comprises date or time information,
wherein the device to be configured is the camera which captured the image and the step of using the configuration information comprises setting an internal clock of the camera.

2. The method of claim 1, wherein the camera processes the image to extract the configuration information.

3. (canceled)

4. (canceled)

5. The method of claim 1, wherein the configuration information further comprises photographic parameters for the camera.

6. A method of automatically configuring a device, the method comprising:
obtaining an image of a scene comprising a machine-readable code containing configuration information for the device;
processing the image to extract the configuration information; and
using the configuration information to configure the device
wherein the step of obtaining the image comprises at least one of:
capturing the image using a camera, or
receiving the image captured by a camera, and
wherein the configuration information comprises date or time information,
wherein the device to be configured is a computer adapted to receive images from the camera which captured the image.

7. The method of claim 1, wherein:
the image has associated time-of-capture metadata generated by an internal clock of the camera; and
the step of using the configuration information comprises comparing the date or time information with the metadata to calculate a relative error of the internal clock of the camera.

8. The method of claim 7, further comprising extrapolating the calculated relative error, so as to calculate the time of capture of other images captured by the same camera.

9. The method of claim 8, comprising using the calculated time of capture of at least one of the images in a method of processing satellite positioning signals, so as to compute a location of capture.

10. The method of claim 1, wherein the scene comprising the machine-readable code comprises a display apparatus showing the machine-readable code, wherein the display is at least one of:
a display of a device connected to a communications network for retrieving the configuration information;
a display of a satellite positioning receiver; and
a display of a clock.

11. A computer program comprising computer program code means adapted to perform all the steps of claim 1 when said program is run on a computer.

12. A computer program as claimed in claim 11, embodied on a computer-readable medium.

13. Apparatus for automatic configuration of a device, the apparatus comprising:
input means, for receiving an image of a scene comprising a machine-readable code containing configuration information for the device; and
a processor
adapted to process the image to extract the configuration information; and
adapted to use the configuration information to configure the device,
wherein the configuration information comprises date or time information,
wherein the device to be configured is the camera which captured the image and the step of using the configuration information comprises setting an internal clock of the camera.

14. Apparatus for automatic configuration of a device, the apparatus comprising:
input means, for receiving an image of a scene comprising a machine-readable code containing configuration information for the device; and
a processor
adapted to process the image to extract the configuration information; and
adapted to use the configuration information to configure the device,
wherein the configuration information comprises date or time information,
wherein the device to be configured is a computer adapted to receive images from the camera which captured the image.
